(19) United States
(12) Patent Application Publication
(10) Pub. No.: US 2026/0066810 A1
(43) Pub. Date: Mar. 5, 2026

(54) POWER CONVERTER AND METHOD FOR OPERATING A POWER CONVERTER

(71) Applicant: Infineon Technologies Austria AG, Villach (AT)

(72) Inventors: Alex PACINI, Villach (AT); Matthias Joachim KASPER, Villach (AT)

(21) Appl. No.: 19/306,350

(22) Filed: Aug. 21, 2025

(30) Foreign Application Priority Data
Aug. 27, 2024 (DE) 102024124420.8

(51) Int. Cl. H02M 7/217

(52) U.S. Cl. CPC H02M 7/2173

(57) ABSTRACT

A power converter and a method are disclosed. The power converter includes an input to receive three alternating input voltages; a switching circuit coupled to the input and comprising a three-phase half-bridge; an autotransformer circuit; and a rectifier circuit. The autotransformer circuit is coupled between the switching circuit and the rectifier circuit, and the rectifier circuit is coupled between the autotransformer circuit and an output of the power converter.

### RELATED APPLICATIONS

This application claims priority to earlier filed German Patent Application Serial Number 102024124 420.8, filed on Aug. 27, 2024, the entire teachings of which are incorporated herein by this reference.

### FIELD

This disclosure relates in general to a power converter and a method for operating a power converter. In particular, the disclosure relates to a single stage three-phase PFC (Power Factor Correction) power converter.

### BACKGROUND

Three-phase PFC power converters are widely used in various kinds of power conversion applications. Examples of such applications include on-board chargers (OBC) for charging a battery of a vehicle, or power supplies for lighting, telecommunication, or computer server applications. A three-phase PFC rectifier is configured to generate a rectified output voltage based on three alternating input voltages each received at a respective input. Furthermore, for controlling a power factor, a three-phase PFC rectifier is configured to control current waveforms of input currents received at the inputs such that, for example, the input currents have the same waveform as the input voltages.

The input voltages received at the inputs are grid voltages received from a power grid, for example. In many cases it is desirable to provide a galvanic isolation between the inputs where the alternating input voltages are received and an output where the rectified output voltage is provided. A conventional three-phase PFC rectifier providing galvanic isolation between the input and the output may include two stages, a first stage configured to generate a rectified voltage (often referred to as a DC link voltage) based on the alternating input voltages, and a second stage configured to generate an output voltage based on the DC link voltage and to provide for a galvanic isolation between the first stage and the output. In this conventional three-phase PFC rectifier, the first stage usually includes three inductors and a DC link capacitor and the second stage usually includes a transformer, an output capacitor and, optionally, an inductor in addition to the transformer. The transformers, the inductors, and the DC link capacitor are bulky and heavy and may take up to 50% of an overall size of the PFC rectifier.

A non-isolated power converter is a power converter without a galvanic isolation between an input and an output. In this type of power converter, however, a varying common mode voltage at the output may result in undesired leakage currents between the output and a reference node, such as ground.

### BRIEF DESCRIPTION

There is a need for a non-isolated single-stage three-phase PFC converter.

One example relates to a power converter. The power converter includes
an input configured to receive three alternating input voltages, a switching circuit coupled to the input and including a three-phase half-bridge, a resonant circuit coupled to a first output node of the switching circuit, an autotransformer circuit, and a rectifier circuit. The autotransformer circuit is coupled between the switching circuit and the rectifier circuit, and the rectifier circuit is coupled between the autotransformer circuit and an output of the power converter.

Another example relates to a method. The method includes operating a power converter. The power converter includes an input configured to receive three alternating input voltages; a switching circuit coupled to the input and including a three-phase half-bridge; a resonant circuit coupled to a first output node of the switching circuit; an autotransformer circuit coupled between the switching circuit and a rectifier circuit; and the rectifier circuit coupled between the autotransformer circuit and an output of the power converter. The method includes generating an alternating voltage based on the three alternating input voltages by the switching circuit in an unregulated fashion, thereby controlling a waveform of the alternating voltage dependent on signal levels of the input voltages, and controlling a power factor of power received at the input.

### BRIEF DESCRIPTION OF DRAWINGS

Examples are explained below with reference to the drawings. The drawings serve to illustrate certain principles, so that only aspects necessary for understanding these principles are illustrated. The drawings are not to scale. In the drawings the same reference characters denote like features.

FIG. 1 shows a circuit diagram of a power converter according to one example, wherein the power converter includes a switching circuit, a resonant circuit, an autotransformer circuit, and a rectifier circuit as discussed herein;

FIGS. 2 and 3 illustrate different examples of the switching circuit as discussed herein;

FIGS. 4A-4B illustrates examples of bidirectionally blocking switches each including two unidirectionally blocking switches as discussed herein;

FIG. 5 illustrates one example of a bidirectionally blocking switch implemented as a HEMT (high electron-mobility transistor) as discussed herein;

FIG. 6 illustrates one example of the resonant circuit as discussed herein;

FIGS. 7-8 illustrate different examples of the rectifier circuit and ways for connecting the rectifier circuit between the autotransformer and an output of the power converter as discussed herein;

FIG. 9 shows a signal diagram of an output voltage of the rectifier circuit illustrated in FIG. 8 is discussed herein;

FIG. 10 illustrates one example of a rectifier circuit with active rectifier elements as discussed herein;

FIGS. 11-13 illustrate further examples of the rectifier circuit and ways for connecting the rectifier circuit between the autotransformer and an output of the power converter as discussed herein;

FIG. 14 illustrates one example of an optional input filter as discussed herein;

FIG. 15 illustrates one example of a power source configured to provide alternating input voltages to the power converter as discussed herein;

FIG. 16 shows signal waveforms of sinusoidal input voltages according to one example as discussed herein;

FIG. 17 illustrate one example of a method for operating the switching circuit as discussed herein;

FIGS. 18A-18B illustrate signal diagrams of an alternating voltage generated in accordance with the method according to FIG. 17 as discussed herein;

FIGS. 19A-19C show different operating states of the switching circuit for illustrating one example for generating the alternating voltage based on the input voltages using the switching circuit as discussed herein;

FIG. 20 shows a block diagram of the control circuit according to one example as discussed herein;

FIG. 21 shows one example of a time duration generator included in the control circuit according to FIG. 20 as discussed herein; and

FIG. 22 shows signal diagrams that illustrate operation of the power converter according to one example as discussed herein.

In the following detailed description, reference is made to the accompanying drawings. The drawings form a part of the description and for the purpose of illustration show examples of how the invention may be used and implemented. It is to be understood that the features of the various embodiments described herein may be combined with each other, unless specifically noted otherwise.

### DETAILED DESCRIPTION

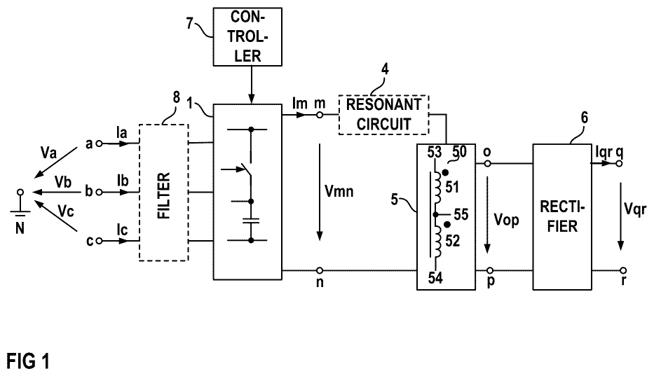

FIG. 1 illustrates a power converter according to one example. The power converter includes an input with three input nodes a, b, c configured to receive three alternating input voltage Va, Vb, Vc, a switching circuit 1 coupled to the input a, b, c and including a three-phase half-bridge, an autotransformer circuit 5, and a rectifier circuit 6. The autotransformer circuit 5 is coupled between the switching circuit 1 and the rectifier circuit 6, and the rectifier circuit 6 is coupled between the autotransformer 4 and an output q, r of the power converter.

According to one example (as illustrated in FIG. 1), the power converter further includes a resonant circuit 4 coupled between a first output node m of the switching circuit 1 and the autotransformer 4. The resonant circuit 4 is optional and may therefore be omitted. If the resonant circuit 4 is omitted, the autotransformer circuit 5 is directly connected to the first output node m of the switching circuit 1.

Referring to FIG. 1, the power converter may further include a controller 7 that is configured to control operation of the switching circuit 1.

According to one example, the power converter is configured to generate a direct output voltage Vqr and/or a direct output current Iqr at the output nodes q, r based on the three alternating input voltage Va, Vb, Vc received at the input a, b, c. This may include that a load provides a direct voltage at the output nodes q, r and the power converter generates a direct output current Iqr at the output nodes q, r.

As can be seen from FIG. 1, the power converter is a non-isolated power converter. This includes that the power converter is devoid of a galvanically isolating barrier, such as, for example, a transformer with a primary winding and a secondary winding galvanically isolated from each other.

The autotransformer 40 included in the autotransformer circuit 5 does not provide for a galvanic isolation between the input a, b, c and the output q, r. Referring to FIG. 1, the autotransformer circuit 5 includes an autotransformer 50 with a single winding connected between a first circuit node 53 and a second circuit node 54 and tapped at a tap 55. A first portion 51 of the winding connected between the first and second circuit nodes 53, 54 may also be referred to as first winding of the autotransformer 50, and a second portion 52 of the winding connected between the first and second circuit nodes may also be referred to as second winding of the autotransformer 50. The first and second windings 51, 52 are connected in series between the first and second circuit nodes 53, 54 and are connected to each other at the tap 55.

A voltage received between the first circuit node 53 and the second circuit node 54 of the autotransformer 50 is also referred to as input voltage and a voltage provided between the tap 55 and the second circuit node 54 is also referred to as output voltage of the autotransformer 50 in the following. A ratio between the input voltage and the output voltage is dependent on where the tap 55 is located along the single winding of the autotransformer. According to one example, the ratio is selected from between 1:1, which is when the first circuit node 53 and the tap 55 are the same node, and 10:1. In particular, the ratio is between 2:1 and 4:1. Such autotransformer 50 does not include a galvanically isolating barrier.

Implementing the power converter as a non-isolated converter may help to reduce an overall size, weight, and resource consumption of the power converter as compared to a conventional power converter including a galvanically isolating barrier.

As compared to a transformer with galvanically isolated primary and secondary windings, for example, the autotransformer 50 is less bulky and lighter.

Moreover, the power converter according to FIG. 1 is a single-stage converter with only one converter stage formed by the switching circuit 1, the autotransformer circuit 5 and the optional resonant circuit 4. This helps to reduce the total number of components, thereby reducing the size of the power converter and saving costs and resources.

In the power converter according to FIG. 1, the switching circuit 1 is configured to generate an alternating voltage Vmn based on the three input voltages Va, Vb, Vc. According to one example, the alternating voltage Vmn provided between the first output node m and a second output node n of the switching circuit 1 has a frequency that is higher than a frequency of each of the three alternating input voltages Va, Vb, Vc. According to one example, the frequency of the alternating voltage Vmn provided by the switching circuit 1 is at least 10 times, at least 100 times, or at least 1000 times the frequency of the alternating input voltages Va, Vb, Vc. According to one example, the three input voltages Va, Vb, Vc have the same frequency.

According to one example, the three input voltages Va, Vb, Vc are sinusoidal voltages. Examples of three sinusoidal input voltages Va, Vb, Vc are explained herein further below.

Optionally, the power converter further includes an input filter 8 coupled between the input nodes a, b, c and the switching circuit 1. The input filter 8 is configured to filter out high frequency current ripples from input currents Ia, Ib, Ic received by the switching circuit 1 at the input a, b, c. One example of the input filter 8 is explained herein further low.

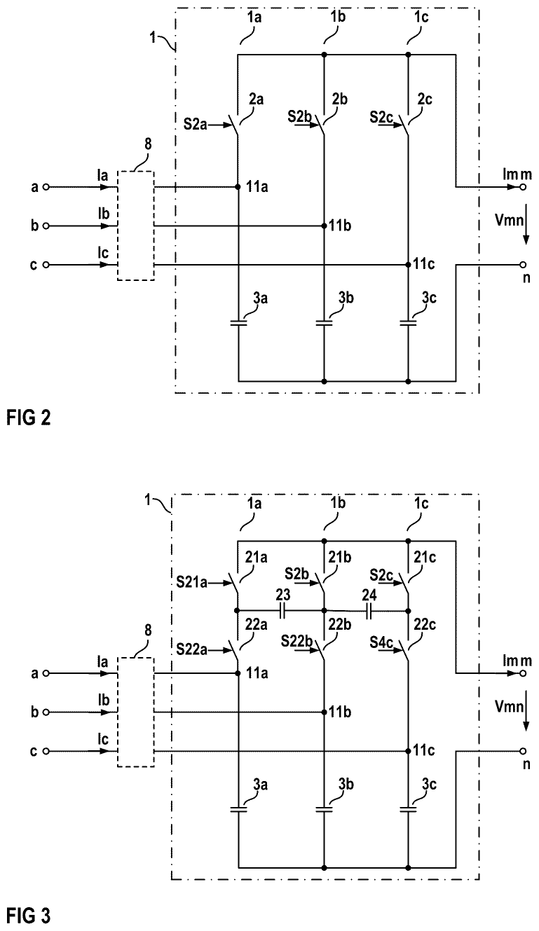

The switching circuit 1 configured to generate the alternating voltage Vmn based on the input voltages Va, Vb, Vc can be implemented in different ways. Two examples are explained with reference to FIGS. 2 and 3 herein below. Each of FIGS. 2 and 3 illustrates a circuit diagram of a switching circuit 1 that includes a three-phase half-bridge according to one example.

Each of the switching circuits according to FIGS. 2 and 3 is configured to selectively connect each of the input nodes a, b, c with only one of the first and second output nodes m, n. More specifically, in the example illustrated in FIGS. 2 and 3, the switching circuit 1 is configured to selectively connect each of the input nodes a, b, c with the first output node m. This is in contrast to a three-phase full-bridge switching circuit, which is configured to selectively connect each of three input nodes with each of two output nodes.

Referring to FIG. 2, the three-phase half-bridge includes three half-bridges 1a, 1b, 1c that each include a switched node (tap) 11a, 11b, 11c, an electronic switch 2a, 2b, 2c connected between the respective switched node 11a, 11b, 11c and the first output node m, and a capacitor 3a, 3b, 3c connected between the respective switched node 11a, 11b, 11c and the second output node n. The capacitors 3a, 3b, 3c may also be referred to as DC blocking capacitors. According to one example, the three capacitors 3a, 3b, 3c at least approximately have the same capacitance. Each of the electronic switches 2a, 2b, 2c switches on or off dependent on a control signal S2a, S2b, S2c that is generated by the control circuit 7.

Referring to FIG. 2, each of the three input nodes a, b, c is coupled to a respective one of the switched nodes 11a, 11b, 11c. This may include that each of the three input nodes a, b, c is directly connected to the respective one of the switched nodes 11a, 11b, 11c, or that each of the three input nodes a, b, c is connected to the respective switched node 11a, 11b, 11c via the optional input filter 8. It should be noted in this regard that the input filter 8 is configured to filter out high-frequency components of the input voltages Va, Vb, Vc and the input currents Ia, Ib, Ic, but does not affect the general waveforms of the voltages Va, Vb, Vc and currents Ia, Ib, Ic. The “general waveforms” are sinusoidal waveforms, for example.

FIG. 3 shows a modification of the switching circuit 1 according to FIG. 2. The switching circuit 1 according to FIG. 3 is different from the switching circuit 1 according to FIG. 3 in that each half-bridge 1a, 1b, 1c includes two electronic switches 21a, 22a, 21b, 22b, 21c, 22c connected in series between the respective switched node 11a, 11b, 11c and the first output node m. A first capacitor 23 is connected between a circuit node at which the first and second switches 21a, 22a of a first one 1a of the half-bridges 1a, 1b, Ic are connected and a circuit node at which the first and second switches 21b, 22b of a second one of the half-bridges 1a, 1b, 1c are connected. Furthermore, a second capacitor 24 is connected between the circuit node at which the first and second switches 21b, 22b of the second half-bridge 1b are connected and the circuit node at which the first and second switches 21c, 22c of a third one of the half-bridges 1a, 1b, 1c are connected.

Each of the first and second electronic switches 21-22c switches on or off dependent on a respective control signal S21a, S21b, S21c, S22a, S22b, S22c that is generated by the control circuit 6. According to one example, the first and second switches connected in series in each half-bridge 1a, 1b, 1c are switched on and off synchronously. That is switches 21a, 22a connected between switched node 11a and the first output node m in half-bridge 1a switch synchronously, switches 21b, 22b connected between switched node 11b and the first output node m in half-bridge 1b switch synchronously, and switches 21c, 22c connected between switched node 11c and the first output node m in half-bridge 1c switch synchronously.

The switches 21a-22c used in the switching circuit 1 according to FIG. 3 may have a lower voltage blocking capability than the switches 2a-2c used in the switching circuit according to FIG. 2. In the switching circuit according to FIG. 2, the voltage that may occur across each of the switches 2a-2c is given by the output voltage Vmn minus the respective input voltage Va, Vb, Vc. In the switching circuit 1 according to FIG. 3, the voltage that may occur across each of the switches 2a, 2b, 2c is lower because the first and second capacitors 23, 24 are charged during operation of the switching circuit 1 and thereby help to reduce the voltages across the switches 21a-21c, 22a-22c as compared to the voltages across the switches 2a-2c in the switching circuit according to FIG. 2. During operation of the switching circuit 1 according to FIG. 3, the voltage across the first capacitor 23 is essentially given by (Va−Vb)/2, which is 50% of a voltage difference between the first and second input voltages Va, Vb, and the voltage across the second capacitor 24 is essentially given by (Vb−Vc)/2, which is 50% of a voltage difference between the second and third input voltages Vb, Vc.

In a three-phase half-bridge switching circuit, such as the three-phase half-bridge switching circuits 1 according to FIGS. 2 and 3, each half-bridge 1a, 1b, 1c includes one or more switching elements in only one bridge leg, such as the bridge leg between the switched node 11a, 11b, 11c and the first output node m, so that each half-bridge 1a, 1b, 1c is configured to connect the respective switched node 11a, 11b, 11c to only one of the output nodes m, n, such as the first output node m. In contrast, a three-phase full-bridge switching circuit includes three half-bridges that include at least one switching element in each of two bridge legs, so that the respective switched node can selectively be connected to each of two different output nodes.

According to one example, the electronic switches in the switching circuit 1 are bidirectionally blocking electronic switches. That is, each of the electronic switches 2a-2c in the switching circuit 1 according to FIG. 2 and each of the electronic switches 21a-21c, 22a-22c in the switching circuit 1 according to FIG. 3 is a bidirectionally blocking electronic switch.

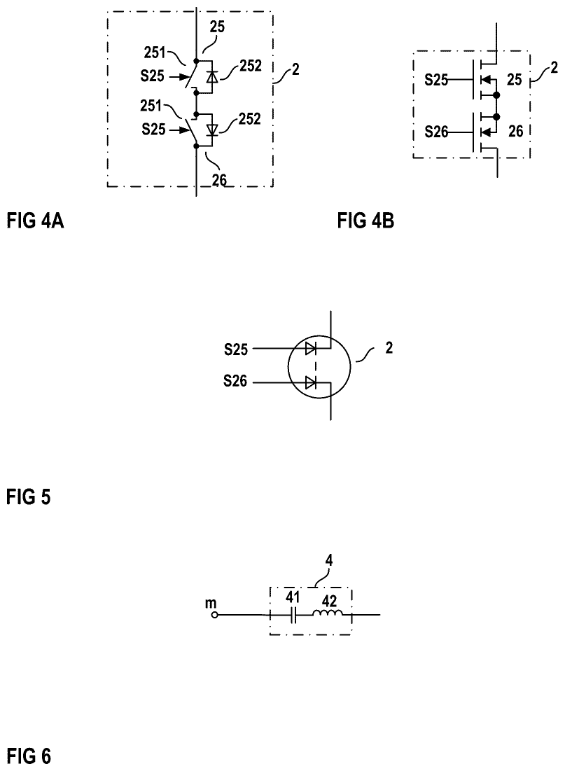

A “bidirectionally blocking electronic switch” is an electronic switch that, in the off-state, is configured to block independent of a polarity of a voltage applied across the electronic switch. A bidirectionally blocking electronic switch may be implemented in various ways. Examples are explained with reference to FIGS. 4A-4B and 5 in the following. In these figures, reference number 2 denotes an arbitrary one of the electronic switches 2a-2c, 21a-21c, 22a-22c in the switching circuits 1 according to FIGS. 2 and 3.

According to FIG. 4A, the bidirectionally blocking switch 2 may include two unidirectionally blocking electronic switches 25, 26 connected in series. These unidirectionally blocking electronic switches 25, 26 may be referred to as partial switches. A “unidirectionally blocking electronic switch” is an electronic switch that, in the off-state, is configured to block when a voltage applied across the switch has a first polarity and to conduct when the voltage has a second polarity opposite the first polarity. A unidirectionally blocking electronic switch can be considered to include a switching element 251, 261 and a freewheeling element 252, 262, such as a diode, connected in parallel with the switching element 251, 261. In the off-state, the switching element 251, 261 blocks independent of the polarity of the voltage across the electronic switch 25, 26, while the freewheeling element 252, 262 blocks when the voltage has the first polarity and conducts when the voltage has the second polarity.

The unidirectionally blocking electronic switches 25, 26 may be implemented in various ways. Basically, any type of electronic switching element and any type of rectifier element connected in parallel with the switching element may be used to implement the bidirectionally blocking electronic switch.

A MOSFET is a unidirectionally blocking electronic switch. Thus, as illustrated in FIG. 4B, the bidirectionally blocking electronic switch 2 may include two MOSFETs (Metal Oxide Semiconductor Field-Effect Transistors) that are connected in series such that internal body diodes of the MOSFETs are connected in anti-series. The body diode of a MOSFET acts as a freewheeling element and makes the MOSFET a unidirectionally blocking electronic switch.

According to another example illustrated in FIG. 5, the bidirectionally blocking electronic switch 2 is a bidirectionally blocking gallium nitride (GaN) switch. Such bidirectionally blocking GaN switch includes two GaN HEMTs (High Electron-Mobility Transistors) as partial switches that are connected in series in such a way that internal freewheeling elements are connected in anti-series. According to one example, the two GaN HEMTs are two single GaN HEMTs connected in series. According to another example, the two GaN HEMTs are monolithically integrated and each have a control node but share the same active area. Thus, a monolithic bidirectionally blocking GaN HEMT has the benefit of using the same active area (instead of two different active areas in the case of two single GaN HEMT is connected in series), which results in a reduced on-resistance, which is the electrical resistance in the on-state.

In each case, the bidirectionally blocking electronic switch 2 is configured to receive two drive signals S25, S26. That is, the bidirectionally blocking electronic switch is configured to receive a respective drive signal S25, S26 for each of the two partial switches. The bidirectionally blocking switch is in the off-state when each of the partial switches is in the off-state and is in the on-state when each of the partial switches is in the on-state. In the off-state, the bidirectionally blocking switch blocks independent of the polarity of the voltage applied across the switch. In the on-state, the bidirectionally blocking switch conducts independent of the polarity of the voltage applied across the switch. Furthermore, the bidirectionally blocking electronic switch 2 can be operated in a unidirectionally blocking/conducting state, which is an operating state in which one of the partial switches is switched on and the other one of the partial switches is switched off.

FIG. 6 illustrates one example of the optional resonant circuit 4. According to the example illustrated in FIG. 6, the resonant circuit 4 is a series resonant circuit. In this example, the resonant circuit 4 includes a capacitor 41 and an inductor 42 connected in series with the first output node m of the switching circuit (not illustrated in FIG. 6). The resonant circuit has a resonant frequency that is defined by an inductance L41 of the inductor 41 and a capacitance C42 of the capacitor 42. According to one example, the frequency of the alternating voltage Vmn generated by the switching circuit 1 has a frequency that is higher than the resonant frequency of the resonant circuit 4. According to one example, the frequency of the alternating voltage Vmn is at least 1.01 times (101%), at least 1.05 times (105%), at least 1.1 times (110%), or at least 1.2 times (120%) the resonant frequency.

According to another example, the frequency of the alternating voltage Vmn is lower than the resonant frequency, such as lower than 99% or lower than 90% of the resonant frequency.

Referring to FIG. 1, the circuit arrangement including the optional resonant circuit 4, the autotransformer 5 and the rectifier 6 receives the alternating voltage Vmn from the switching circuit 1 and generates the output voltage Vqr and the output current Iqr based on the alternating voltage Vmn and an output current Im provided by the switching circuit 1. Different examples of the rectifier circuit 6 are explained in the following.

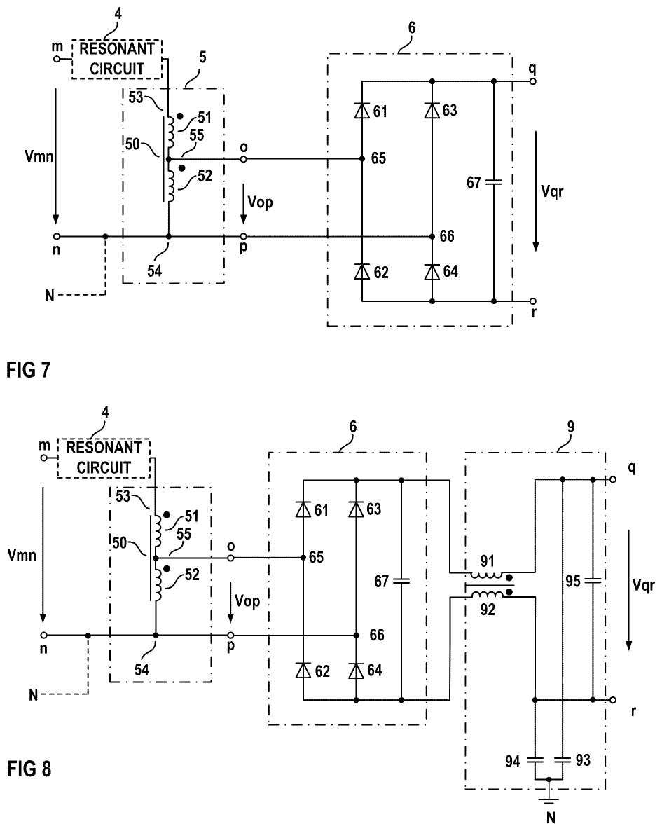

According to one example illustrated in FIG. 7 the autotransformer 15 is connected between the resonant circuit 4 and the second output node n of the switching circuit 1 in that the first circuit node 53 is connected to the resonant circuit 4 and the second circuit node 54 is connected to the second output node n of the switching circuit 1. In this example, the tap 55 forms a first output node o and the second circuit node 54 forms a second output node p of the transformer circuit 5. An autotransformer output voltage Vop is available between the first and second output nodes o, p, which are collectively referred to as output of the autotransformer circuit 5 and the autotransformer 50 in the following.

Referring to FIG. 7, the autotransformer output voltage Vop is received by the rectifier circuit 6 which is configured to generate the output voltage Vqr based on the autotransformer output voltage Vop. Referring to the above, the output voltage Vmn provided by the switching circuit 1 is an alternating voltage. Consequently, the input voltage of the autotransformer 50 is an alternating voltage, so that the autotransformer output voltage Vop, which is a scaled version of the input voltage, is also an alternating voltage. The rectifier circuit 6 is configured to rectify the alternating autotransformer output voltage Vop and provide the direct output voltage Vqr at the output nodes q, r of the power converter. The input voltage of the autotransformer 50 is either the alternating voltage Vmn provided by the switching circuit 1 (when the power converter is devoid of the resonant circuit 4), or a modified output voltage modified by the resonant circuit 4.

In the example illustrated in FIG. 7, the rectifier circuit 6 includes a rectifier full-bridge with a first rectifier half-bridge and a second rectifier half-bridge that each include a series circuit with a first rectifier element 61, 63 and a second rectifier element 62, 64 connected between the first and second output nodes q, r and that each include a half-bridge node 65, 66 (midpoint) at which the first and second rectifier elements 61, 63, 62, 64 are connected. The first output node o of the autotransformer circuit 5 is connected to the half-bridge node 65 of the first half-bridge, and the second output node p of the autotransformer circuit 5 is connected to the half-bridge node 66 of the second half-bridge, so that the autotransformer output voltage Vop is received between the half-bridge nodes 65, 66 of the rectifier full bridge.

Referring to FIG. 7, the rectifier circuit 6 may further include an output capacitor 67 connected between the output nodes q, r.

The rectifier elements 61-64 are conventional passive rectifier elements, such as PN diodes (as illustrated) or Schottky diodes, for example. The rectifier elements 61-64 are connected such that, at each time, one rectifier element of each half-bridge is conducting. In the example illustrated in FIG. 7, for example, the first rectifier element 61 of the first half-bridge and the second rectifier element 64 of the second half-bridge are conducting when the autotransformer output voltage Vop is positive, and the second rectifier element 62 of the first half-bridge and the first rectifier element 63 of the second half-bridge are conducting when the autotransformer output voltage Vop is negative.

Referring to FIG. 1, the input voltages Va, Vb, Vc received by the switching circuit 1 are referenced to a common reference node N, which is also referred to as ground node in the following. According to one example illustrated in dashed lines in FIG. 7, the second output node n of the switching circuit 1 is connected to the ground node N, so that the alternating voltage Vmn provided by the switching circuit 1 is referenced to the ground node N.

In a way not illustrated in detail, the first and second output nodes q, r may capacitively be coupled to the ground node N. Such capacitive coupling between the output nodes q, r and the ground node N may result in an undesirable leakage current between the output nodes q, r and the ground node N. A leakage current between the output nodes q, r and the ground node N may occur, in particular, when an oscillating common mode voltage Vom occurs at the output nodes q, r. The common mode voltage Vcm is given by

$$Vcm = \frac{Vq + Vr}{2} , \qquad ( 1 )$$

where Vq denotes the voltage between the first output node q and the ground node N, and Vr denotes the voltage between the second output node r and the ground node N.

Referring to FIG. 8, in order to avoid or reduce an oscillating common mode voltage, the power converter may further include an output filter 9 connected between the rectifier circuit 6 and the output nodes q, r. More specifically, the output filter 9 is connected between the output capacitor 65 of the rectifier circuit 6 and the output nodes q, r.

The output filter 9 includes at least one choke 91, 92 connected between the rectifier circuit 6 and the output nodes q, r. According to one example illustrated in FIG. 8, the output filter 9 includes a first choke 91 connected between the rectifier circuit 6 and the first output node q and a second choke 92 connected between the rectifier circuit 6 and the second output node r, wherein the first and second chokes 91, 92 are inductively coupled. Furthermore, the output filter 9 may include an output capacitor 92 connected between the output nodes q, r.

Referring to FIG. 8, the output filter 9 may further include a capacitive filter with a first capacitor 93 connected between the first output node q and a reference node, and a second capacitor 94 connected between the second output node r and the reference node. The reference node is the ground node N, for example.

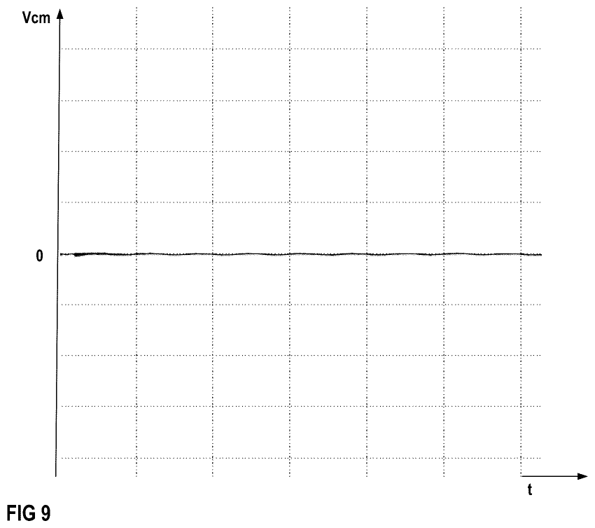

FIG. 9 shows a signal diagrams that illustrates the common mode voltage Vcm at the output q, r in a power converter according to FIG. 8 when the input voltages Va, Vb, Vc are sinusoidal input voltages. As can be seen from FIG. 9, the common mode voltage Vcm is essentially zero.

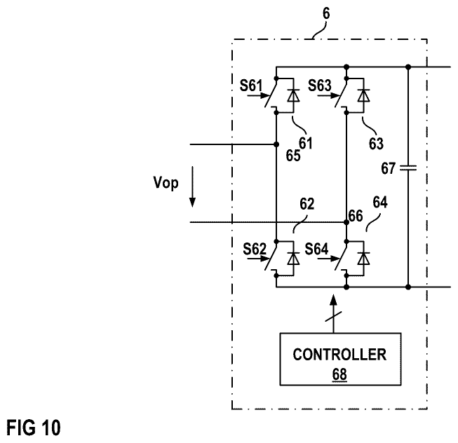

In the examples illustrated in FIGS. 7 and 8, the rectifier elements 61-64 of the rectifier circuit 6 are passive rectifier elements. However, implementing the rectifier circuit 6 with passive rectifier elements is only an example. For reducing conduction losses, the passive rectifier elements may be replaced by active rectifier elements. FIG. 10 illustrates one example of a rectifier circuit 6 implemented with active rectifier elements.

Referring to FIG. 10, the rectifier circuit 6 includes active rectifier elements 61-64 instead of passive rectifier elements. The active rectifier elements 61-63 are controlled by a rectifier controller 68. Each of the active rectifier elements 61-64 may include an electronic switch and a passive rectifier element, such as a diode, connected in parallel with the respective electronic switch. According to one example, the controller 68 is configured to detect whether the passive rectifier element of the respective active rectifier element is in a forward biased (conducting) or a reverse biased (blocking) state and is configured to switch on those electronic switches that are connected in parallel to a forward biased passive rectifier element. It should be noted that a rectifier circuit 6 with active rectifier elements 61-64 of the type illustrated in FIG. 10 is commonly known, so that no further explanation is required in this regard.

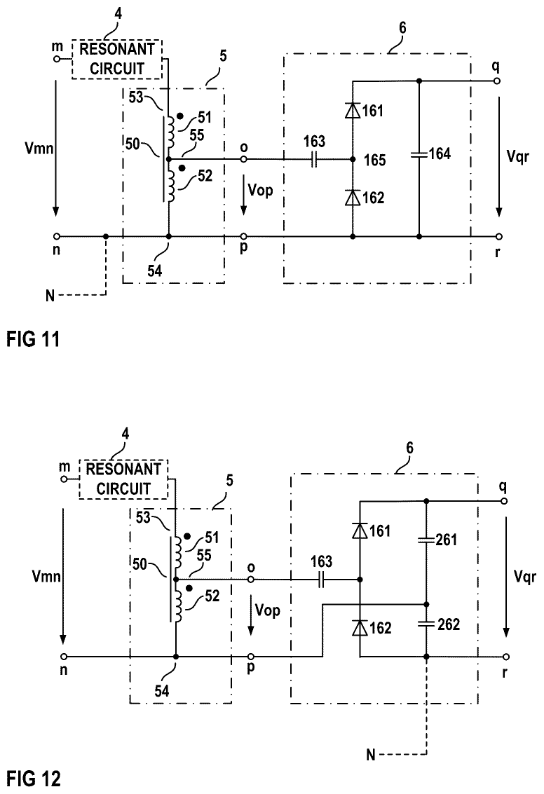

FIG. 11 illustrates a rectifier circuit 6 according to another example. In this example, the rectifier circuit 6 includes one rectifier half-bridge with a first rectifier element 161 and a second rectifier element 162 connected in series between the first and second output nodes q, r. The second output node r is connected to the second output node of the autotransformer 50 and the second output node n of the switching circuit 1 in this example. According to one example illustrated in dashed lines in FIG. 11, these common second output nodes r, p, n are connected to the ground node N. In this way, a leakage current between the output nodes q, r and the ground node N can be avoided. No output filter of the type illustrated in FIG. 8 is required.

Referring to FIG. 11, a half-bridge node 165 of the rectifier half-bridge, which is the circuit node at which the rectifier elements 161, 162 are connected, is connected to the first autotransformer output node o via a capacitor 163. Furthermore, the rectifier circuit 6 may include an output capacitor 164 connected between the output nodes q, r of the power converter.

FIG. 12 shows a modification of the rectifier circuit 6 according to FIG. 11. The rectifier circuit 6 according to FIG. 12, includes two output capacitors 261, 262 connected in series between the output nodes q, r and connected with each other at a midpoint 263. According to one example, the capacitors 261, 262 have the same capacitance. The midpoint 263 is connected to the second output node p of the autotransformer circuit 5, so that the second output node p of the autotransformer circuit 5 and the second output node r of the power converter are not directly connected.

The second output node r of the power converter is connected to the ground node N, for example. Thus, in the same way as in the power converter according to FIG. 11, a leakage current between the output nodes q, r and the ground node N can be avoided.

In the examples illustrated in FIGS. 11 and 12, the rectifier elements 161, 162 are passive rectifier elements. This, however, is only an example. Is also possible to implement the rectifier elements as active rectifier elements of the type illustrated in FIG. 10 that include an electronic switch and a passive rectifier element connected in parallel with the electronic switch.

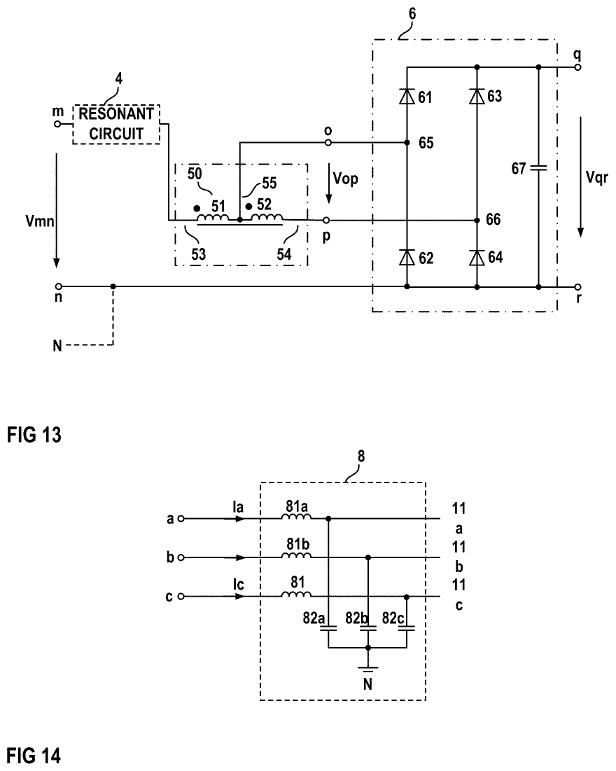

FIG. 13 shows a circuit arrangement with the optional resonant circuit 4, the autotransformer circuit 5 and the rectifier circuit 6 according to another example. The circuit arrangement shown in FIG. 13 is based on the circuit arrangement according to FIG. 7 and includes a rectifier circuit 6 implemented as a full-bridge rectifier. Just for the purpose of illustration, the rectifier circuit 6 is in accordance with the example illustrated in FIGS. 7 and 8 and includes four passive rectifier elements. This, however, is only an example. It is also possible to implement the rectifier elements as active rectifier elements in accordance with the example illustrated in FIG. 9.

The circuit arrangement shown in FIG. 13 is different from the circuit arrangement according to FIG. 7 in that the second circuit node 54, p of the autotransformer 50 is connected to the half-bridge node 66 of the second rectifier half-bridge, but the second circuit node 54, p of the autotransformer 50 is not connected to the second output node n of the switching circuit 1 and the second output node r of the power converter. The second output node n of the switching circuit 1 and the second output node r of the power converter are connected to each other.

Furthermore, the second output nodes n, r of the switching circuit 1 and the power converter are connected to the ground node N, for example. Thus, a leakage current between the output nodes q, r and the ground node N can be avoided, so that an output filter of the type illustrated in FIG. 8 is not required.

FIG. 14 illustrates one example of the input filter 8. In this example, the filter 8 includes three inductors 81a, 81b, 81c, wherein each of these inductors 81a, 81b, 81c is connected between a respective one of the input nodes a, b, c and the respective switched node 11a, 11b, 11c of the switching circuit 1. Furthermore, a capacitor 82a, 82b, 82c is connected between each switched node 11a, 11b, 11c and the ground node N. Implementing the filter 8 as illustrated in FIG. 14, however, is only an example. Any other type of input filter configured to filter out high frequency current ripples may be used as the input filter 8 in the power converter as well.

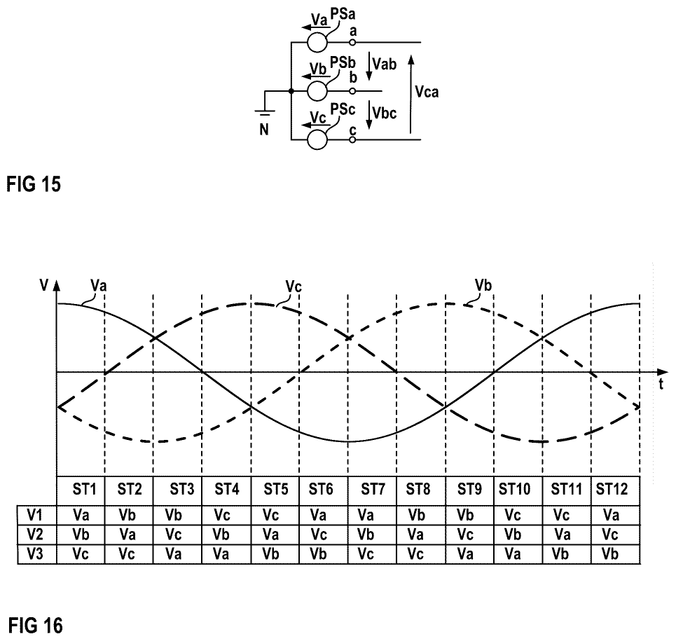

FIG. 15 schematically illustrates one example of a power supply configured to provide the alternating input voltages Va, Vb, Vc received at the input nodes a, b, c of the power converter. In this example, the power supply includes three power sources PSa, PSb, PSc each connected between a respective one of the three input nodes a, b, c and the ground node N. Each of these power sources PSa, PSb, PSc provides a respective one of the input voltages Va, Vb, Vc. The power supply is a three-phase power grid, for example.

Referring to the above, the input voltages Va, Vb, Vc may be sinusoidal input voltages. FIG. 16 shows signal diagrams of three sinusoidal input voltages Va, Vb, Vc, which may be provided by a three-phase power grid. FIG. 16 shows the signal waveforms over one period of each of these input voltages Va, Vb, Vc. Referring to FIG. 16, there is a phase shift between each pair of these input voltages Va, Vb, Vc, wherein the phase shift is 120° (2π/3), for example. A frequency of the input voltages Va, Vb, Vc, which is the reciprocal of the duration of one period, is 50 Hz or 60 Hz, for example. An RMS (root mean square) value of the input voltages Va, Vb, Vc is 230 VRMS or 110 VRMS, for example (wherein the three input voltages Va, Vb, Vc have the same RMS value). The amplitude of each of the input voltages Va, Vb, Vc is \sqrt{2} times the RMS value. As can be seen from FIG. 16, each of the three sinusoidal input voltages Va, Vb, Vc periodically changes between a negative minimum voltage level and a positive maximum voltage level. The magnitude (absolute value) of the minimum voltage level equals the magnitude of the maximum voltage level and equals the amplitude.

Over one period of an input voltage system with three input voltages Va, Vb, Vc at each time (except for time instances at which two of the three voltages Va, Vb, Vc cross) one of the input voltages Va, Vb, Vc is the highest input voltage, one of the input voltages Va, Vb, Vc is the second highest input voltage, and one of the input voltages Va, Vb, Vc is the lowest input voltage. It should be noted that “highest”, “second highest” and “lowest” relates to the magnitude of the respective voltage, so that the highest input voltage is that one of the input voltages Va, Vb, Vc that has the highest magnitude, the second highest input voltage is that one of the input voltages Va, Vb, Vc that has the second highest magnitude, and the lowest input voltage is that one of the input voltages Va, Vb, Vc that has the lowest magnitude.

As the input voltages Va, Vb, Vc are alternating input voltages and are out of phase with each other the input voltage being the highest input voltage, the input voltage being the second highest input voltage, and the input voltage being the lowest input voltage changes several times over one period of the input voltages Va, Vb, Vc. As can be seen from FIG. 16, the input voltage being the highest input voltage is the same for a certain time period, the input voltage being the second highest input voltage is the same for a certain time period, and the input voltage being the lowest input voltage is the same for a certain time period. More specifically, in an input voltage system that includes three sinusoidal input voltages with a mutual phase shift of 120° there are 12 different time segments in each period of the input voltage system such that during each of these 12 different times segments the same input voltage is the highest input voltage, the same input voltage is the second highest input voltage, and the same input voltage is the lowest input voltage. These 12 different times segments are also referred to as states of the input voltage system and are labeled with ST1-ST12 in FIG. 16. The duration of each of the 12 states ST1-ST12 is 1/12 (30°, p/6) of one period of the input voltage system.

FIG. 16 includes a table that illustrates which of the input voltages Va, Vb, Vc in each of the different states ST1-ST12 is the highest input voltage, the second highest input voltage, and the lowest input voltage. In FIG. 16, V1 denotes the highest input voltage, V2 denotes the second highest input voltage, and V3 denotes the lowest input voltage.

In a first state ST1 of the input voltage system, for example, the highest input voltage V1 is the first input voltage Va, V1=Va; the second highest input voltage V2 is the second input voltage Vb, V2=Vb; and the lowest input voltage V3 is the third input voltage Vc, V3=Vc. In a sixth state ST6 of the input voltage system, for example, the highest input voltage V1 is the first input voltage Vc, V1=Va; the second highest input voltage V2 is the third input voltage Va, V2=Vc; and the lowest input voltage V3 is the second input voltage Vb, V3=Vb.

In each of the different states ST1-ST12 the highest input voltage V1 has a first polarity and the second highest input voltage V2 and the lowest input voltage V3 have a second polarity opposite the first polarity. In the first state ST1, for example, the highest input voltage V1 (which is the first input voltage Va) is positive, while the second highest input voltage V2 (which is the second input voltage Vb) and the lowest input voltage V3 (which is the third input voltage Vc) are negative. In the sixth state ST6, for example, the highest input voltage (which is the first input voltage Vout for) is negative, while the second highest input voltage V2 (which is the third input voltage Vc) and the lowest input voltage V3 (which is the second input voltage Vb) are positive.

As can be seen from FIG. 16, the 12 states ST1-ST12 include six pairs of states such that in the two states of each pair the same input voltage is the highest input voltage, the same input voltage is the second highest input voltage V2, and the same input voltage is the lowest input voltage V3. These six pairs of states are: (ST1, ST7), (ST2, ST8), (ST3, ST9), (ST4, ST10), (ST5, ST11), (ST6, ST12). However, the highest input voltages in each pair have opposite polarities, the second highest input voltages in each pair have opposite polarities, and the lowest input voltages in each pair have opposite polarities. Thus, the 12 states ST1-S12 of the input voltage system that occur during one period of the input voltage system are unique (mutually different). That is, only one of the 12 states include a certain highest input voltage with a certain polarity, a certain second highest input voltage with a certain polarity, and a certain lowest input voltage with a certain polarity.

According to one example, generating the alternating voltage Vmn by the switching circuit 1 includes generating the alternating voltage Vmn based on the three alternating input voltages Va, Vb, Vc in an unregulated fashion by the switching circuit 1. Generating the alternating voltage Vmn includes controlling a waveform of the alternating voltage Vmn dependent on signal levels of the input voltages Va, Vb, Vc and controlling a power factor of power Pin received at the input a, b, c.

The power Pin received at the input of the power converter is given by the sum of the powers received at the individual inputs a, b, c, wherein the power received at each input a, b, c is given by the voltage Va, Vb, Vc received at the respective input a, b, c multiplied with the current Ia, Ib, Ic received at the respective input a, b, c,

$$Pin = Va \cdot Ia + Vb \cdot Ib + Vc \cdot Ic . \qquad ( 2 )$$

According to one example, it is desired to operate the power converter with a power factor of more than 90%, more than 95%, or even more than 99%. The power factor is 100% if the (alternating) current Ia, Ib, Ic received at each of the input nodes a, b, c is exactly proportional to the respective input voltage Va, Vb, Vc and the same proportionality factor applies for the relationship between each of the input voltages Va, Vb, Vc and the corresponding input current Ia, Ib, Ic.

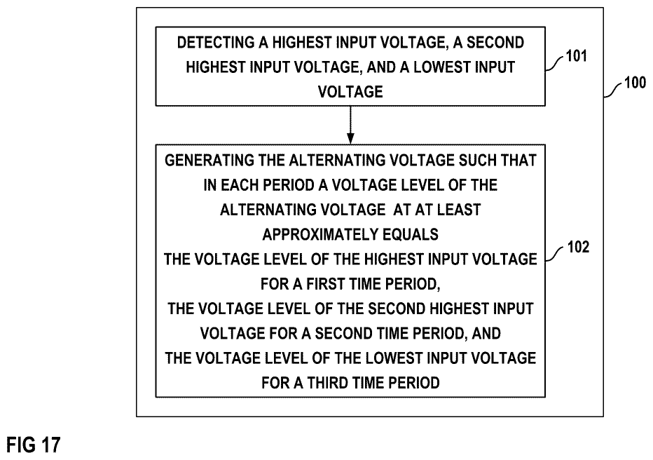

One way of generating the alternating voltage Vmn is illustrated in FIG. 17. Referring to FIG. 17, a method 100 of generating the alternating voltage Vmn dependent on signal levels of the input voltages Va, Vb, Vc includes (101) detecting the highest input voltage V1, the second highest input voltage V2, and the lowest input voltage V3 of the three input voltages Va, Vb, Vc; and (102) generating the alternating voltage Vmn such that in each period of the alternating voltage Vmn the voltage level of the alternating voltage Vmn at least approximately equals the voltage level of the highest input voltage V1 for a first time period, the voltage level of the second highest input voltage V2 for a second time period, and the voltage level of the lowest input voltage V3 for a third time period.

The voltage level of the alternating voltage Vmn being “at least approximately” equal to the voltage level of the highest, the second highest, or the lowest voltage level includes that in an ideal case, in which there are no losses in the switching circuit 1 and the filter 8, the voltage level of the alternating voltage Vmn equals the voltage level of the respective one of the highest, the second highest, or the lowest input voltage Va, Vb, Vc. In a real system, however, such losses may reduce the magnitude of the alternating voltage Vmn as compared to the magnitude of the respective one of the highest, the second highest, and the lowest input voltage V1, V2, V3. Thus, the magnitude of the alternating voltage Vmn equals the magnitude of the respective one of the highest, the second highest, or the lowest input voltage V1, V2, V3 minus inevitable losses in the switching circuit 1 and the filter 8.

In the method according to FIG. 17, generating the alternating voltage Vmn based on the input voltages Va, Vb, Vc includes, in each period of the alternating voltage Vmn, connecting the first output node m to that one of the input nodes a, b, c receiving the highest input voltage V1 for the first time duration, to that one of the input nodes a, b, c receiving the second highest input voltage V2 for the second time duration, and to that one of the input nodes a, b, c receiving the lowest input voltage V3 for the third time duration. At each time instance, the polarity of the alternating voltage Vmn equals the polarity of the input voltage that forms the alternating voltage Vmn at the respective time instance.

Referring to the above, in the switching circuit 1 with the three-phase half-bridge, the second output node n is coupled to each of the switched nodes 11a, 11b, 11c via a respective one of the three capacitors 3a, 3b, 3c. The electrical potential at the second output node n at least approximately equals the electrical potential at the reference node N, in particular when the input voltages Va, Vb, Vc are sinusoidal voltages with a mutual phase shift of 120°. Thus when the switching circuit 1 couples the first output node m to a respective one of the input nodes a, b, c the voltage level of the alternating voltage Vmn at least approximately equals the voltage level of the input voltage Va, Vb, Vc at the respective input node a, b, c.

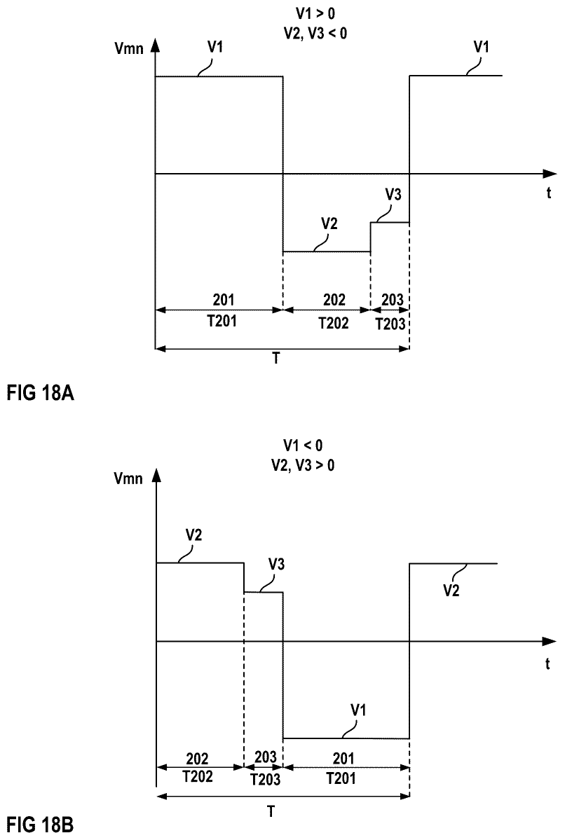

FIGS. 18A-18B schematically illustrate examples of the alternating voltage Vmn generated in accordance with the method according to FIG. 17. Each of FIGS. 18A-18B illustrates one period of the alternating voltage Vmn. In FIGS. 18A-18B, T denotes the duration of one period. The frequency f of the alternating voltage Vmn is the reciprocal of the duration T of one period, f=1/T. According to one example, the frequency f of the alternating voltage Vmn is fixed. Referring to the above, the frequency f of the alternating voltage Vmn may be higher than the resonant frequency of the optional resonant circuit 4.

Referring to the above, the frequency f of the alternating voltage Vmn is much higher than the frequency of the alternating input voltages Va, Vb, Vc and, for example, is at least 1000 (103) times the frequency of the input voltages Va, Vb, Vc so that each of the input voltages Va, Vb, Vc can be considered to be essentially equal over one duration of the alternating voltage Vmn. According to one example, the frequency f of the alternating intermediate voltage Vmn is selected from between 100 kHz and 2 MHz, in particular from between 300 kHz and 1 MHz.

FIG. 18A illustrates one period of the alternating voltage Vmn in a scenario in which the highest input voltage V1 is positive and the second highest input voltage V2 and the lowest input voltage V3 are negative. FIG. 18B illustrates one period of the alternating voltage Vmn in a scenario in which the highest input voltage V1 is negative and the second highest input voltage V2 and the lowest input voltage V3 are positive. In each example, one period of the alternating voltage Vmn includes three time periods (time segments), (a) a first time period 201 in which the voltage level of the alternating voltage Vmn (at least approximately) equals the voltage level of the highest input voltage V1; (b) a second time period 202 in which the voltage level of the alternating voltage Vmn (at least approximately) equals the voltage level of the second highest input voltage V2; and a third time period 203 in which the voltage level of the alternating voltage Vmn (at least approximately) equals the voltage level of the lowest input voltage V3. In FIGS. 18A-18B, T201 denotes a time duration of the first time period 201, T202 denotes a time duration of the second time period 202, and T203 denotes a time duration of the third time period 203.

In the examples illustrated in FIGS. 18A-18B each of the first, second, and third time periods 201, 202, 203 is a contiguous time period. This, however, is only an example it is also possible to subdivide each of these time periods into two or more sub-periods and to distribute the individual sub-periods over the period T in an arbitrary way. This, however, increases the number of switching operations of the switching circuit 1 and may result in increased switching losses.

In the example illustrated in FIG. 18A, the first, second, and third time periods 201, 202, 203 occur in the following order: 201-202-203, and in the example illustrated in FIG. 18B, the first, second, and third time period 201, 202, 203 occur in the following order: 202-203-201. This, however, is only an example. The order in which these time period 201, 202, 203 occur, is arbitrary. In the example illustrated in FIG. 18A, for example, the individual time periods may also occur in the following order: 201-203-202, and in the example illustrated in FIG. 18B, for example, the individual time period may also occur in one of the following orders: 203-202-201.

Referring to the above, the time duration T of one period of the alternating voltage Vmn is so short as compared to the duration of one period of the input voltages Va, Vb, Vc, so that the input voltages Va, Vb, Vc can be considered to be essentially constant over this time duration T.

Referring to the above, in each of the different states ST1-ST12 the highest input voltage V1 has a polarity different from the polarities of the second highest input voltage V2 and the lowest input voltage V3. Thus, by selecting the highest input voltage V1 to form the voltage Vmn for the first time duration T201, selecting the second highest input voltage V2 to form the voltage Vmn for the second time duration, and selecting the lowest input voltage V3 to form the voltage Vmn for the third time duration T203 the alternating character of the voltage Vmn is achieved. When the highest input voltage V1 is positive and the second highest and lowest input voltages V2, V3 are negative, the highest input voltage V1 forms a positive half-period and the second highest and lowest input voltages V2, V3 form a negative half-period of the alternating voltage Vmn. When the highest input voltage V1 is negative and the second highest and lowest input voltages V2, V3 are positive, the highest input voltage V1 form a negative half-period and the second highest and lowest input voltages V2, V3 form a positive half-period of the alternating voltage Vmn.

According to one example, the individual time periods are generated such that the second and third time periods 202, 203 are timely successive time periods. Furthermore, the individual time periods of the alternating voltage Vmn may be generated such that the polarity of the alternating voltage Vmn changes at the end of one time period T and the beginning of the following time period T. If, for example, the input voltage system changes from one state in which the highest input voltage V1 is positive to another state in which the highest input voltage V1 is negative, the order in which the individual time periods occur may change from the order illustrated in FIG. 18A to the order illustrated in FIG. 18B or from the order illustrated in FIG. 18B to the order illustrated in FIG. 18A, so as to achieve a change of polarity of the alternating voltage Vmn between two successive periods.

According to one example, the duration T201 of the first time period 201 at least approximately equals 50% of the time duration T of one period of the alternating voltage Vmn,

$$T 201 \approx 0.5 \cdot T . \qquad ( 3 a )$$

In this example, an overall duration of the first and second time periods 202, 203 at least approximately equals 50% of the time duration T of one period of the alternating voltage Vmn,

$$T 202 + T 203 \approx 0.5 \cdot T . \qquad ( 3 b )$$

It can be shown that by suitably adjusting the second and third time durations T202, T203 under consideration of equation (3b) a PFC functionality of the power converter can be achieved. “Achieving a PFC functionality”, according to one example, includes that the power factor of the power Pin received at the input is higher than 90%, higher than 95%, or even higher than 99%.

As explained above, the alternating voltage Vmn is generated by the switching circuit 1 based on the input voltages Va, Vb, Vc, wherein the switching circuit 1 is controlled by the controller 7. The switching circuit 1, controlled by the controller 7, may have three different operating states. In each of these operating states there is an electrically conductive path between one of the switched nodes 11a, 11b, 11c and the first output node m, so that the input node a, b, c connected to the respective switched node 11a, 11b, 11c is connected to the first output node m, while conductive paths between the other two of the switched nodes 11a, 11b, 11c and the first output node m are interrupted. In the switching circuit according to FIG. 2, for example, a conductive path between one of the switched nodes 11a, 11b, 11c and the first output node m can be achieved by switching on the respective electronic switch 2a, 2b, 2c. In the switching circuit according to FIG. 3, for example, a conductive path between one of the switched nodes 11a, 11b, 11c and the first output node m can be achieved by switching on the first and second electronic switches 21a-21c, 22a, 22c connected in series between the respective switched node 11a, 11b, 11c, and the first output node m.

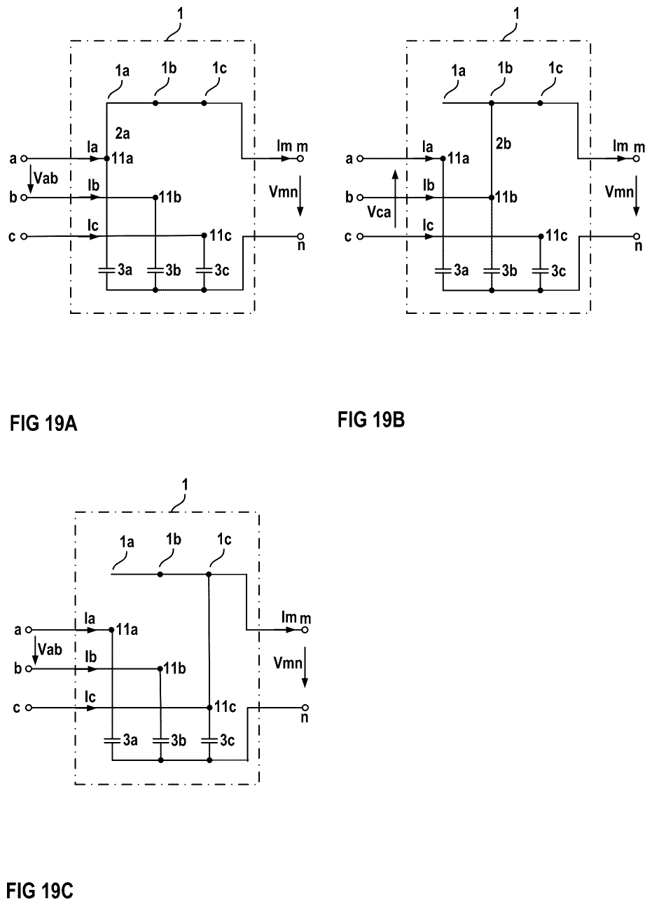

The three different operating states of the switching circuit 1 are schematically illustrated in FIGS. 19A-19C. In each of these figures, a conductive path between one of the first, second, and third switched nodes 11a, 11b, 11c and the output node m is represented by a solid line, and an interrupted conductive path is represented by a missing line between the respective switched node 11a, 11b, 11c and the first output node m.

FIG. 19A illustrates a first operating state, which is an operating state in which there is a conductive path between the first switched node 11a and the first output node m and in which conductive paths between the second switched node 11b and the first output node m and between the third switched node 11c and the first output node m are interrupted.

FIG. 19B illustrates a second operating state, which is an operating state in which there is a conductive path between the second switched node 11b and the first output node m and in which conductive paths between the first switched node 11a and the first output node m and between the third switched node 11c and the first output node m are interrupted.

FIG. 19C illustrates a third operating state, which is an operating state in which there is a conductive path between the third switched node 11c and the first output node m and in which conductive paths between the first switched node 11a and the first output node m and between the second switched node 11b and the first output node m are interrupted.

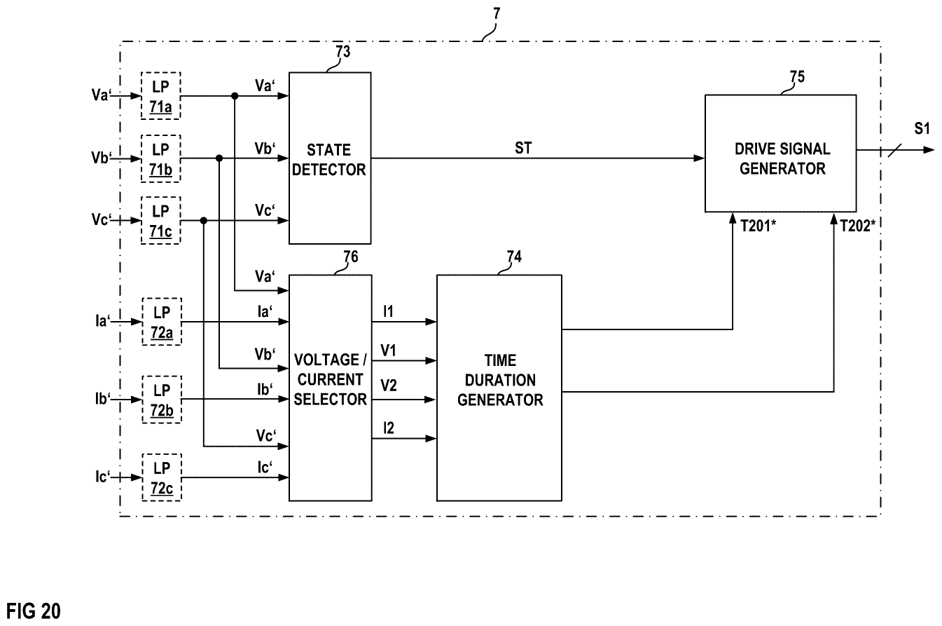

One example of a controller 7 that is configured to detect the state of the input voltage system and control operation of the switching circuit 1 in accordance with the detected state is illustrated in FIG. 20 and explained in the following.

FIG. 20 shows a block diagram of one example of the controller 7. It should be noted that the block diagram according to FIG. 20 illustrates the functionality rather than the implementation of the controller 7. According to one example, the controller 7 may be implemented using dedicated circuitry. According to another example, the controller 7 may include a microcontroller that executes a software that is configured to operate the microcontroller in such a way that the functionality illustrated in FIG. 20 is implemented.

Referring to FIG. 20, the controller 7 receives input voltage signals Va′, Vb′, Vc′ representing the input voltages Va, Vb, Vc and input current signals Ia′, Ib′, Ic′ representing the input currents Ia, Ib, Ic. The input voltage signals Va′, Vb′, Vc′, which may also be referred to as measured input voltages can be obtained using conventional voltage sensors. The input current signals Ia′, Ib′, Ic′, which may also be referred to as measured input currents can be obtained using conventional voltage sensors. Such voltage and current sensors are commonly known so that no further explanation is required in this regard.

According to one example, the input voltages Va, Vb, Vc and the input currents Ia, Ib, Ic are measured between the input filter 8 and the switching circuit 1. Referring to the above, the switching circuit 1 operates at a much higher frequency than the frequency of the input voltages Va, Vb, Vc for generating the alternating voltage Vmn. The switched-mode operation of the switching circuit 1 may cause voltage ripples of the input voltages Va, Vb, Vc and current ripples of the input currents Ia Ib, Ic measured between the input filter 8 and the switching circuit 1. To prevent such current and voltage ripples from negatively affecting operation of the power converter, the measured input voltages Va′, Vb′, Vc′ may be filtered by respective filters 71a, 71b, 71c to obtain filtered measured input voltages. Furthermore, the measured input currents Ia′, Ib′, Ic′ may be filtered by respective filters 72a, 72b, 72c to obtain filtered measured input currents.

The filters 71a, 71b, 71c, 72a, 72b, 72c are low-pass filters, for example. According to one example, the low-pass filters are configured to average the measured input currents Ia′ Ib′, Ic′ and measured input voltages Va′, Vb′, Vc′ over time durations that are between about one time and 100 times, in particular, between 10 times and 50 times the period T of the alternating voltage Vmn.

According to another example, the input voltages Va, Vb, Vc and the input currents Ia, Ib, Ic are measured directly at the inputs a, b, c, that is, between the inputs a, b, c and the input filter 8. In this case, the filters 71a, 71b, 71c, 72a, 72b, 72c may be omitted.

Referring to FIG. 20, a state detector 73 receives the measured (and optionally filtered) input voltages Va′, Vb′, Vc′, which represent the input voltages Va, Vb, Vc, and detects the state of the input voltage system. That is, based on the measured input voltages Va′, Vb′, Vc′, the state detector 73 detects that one of the 12 possible states the input voltage system is currently in. The state detector 73 may detect the state of the input voltage system by detecting which one of the input voltages Va, Vb, Vc is currently the highest input voltage V1, which one of the input voltages Va, Vb, Vc is currently the second highest input voltage V2, and which one of the input voltages Va, Vb, Vc is currently the lowest input voltage V3.

A state signal ST output by the state detector 73 represents the state of the input voltage system detected by the state detector 73. A drive signal generator 75 receives the state signal ST and receives a first time duration reference T201* and a second time duration reference T202* from a time duration generator 74. The first time duration reference T1* represents the desired time duration T201 in which the voltage level of the alternating voltage Vmn equals the voltage level of the highest input voltage V1. The second time duration reference T202* represents the desired time duration T202 in which the voltage level of the alternating voltage Vmn equals the voltage level of the second highest input voltage V2. The drive signal generator 75 drives the electronic switches included in the switching circuit 1 for controlling the operation state of the switching circuit 1. In FIG. 20, S1 represents the plurality of control signals generated by the drive signal generator 75 for controlling operation of the electronic switches in the switching circuit 1.

As can be seen from FIGS. 18A-18B and 19A-19C, in each period of the alternating voltage Vmn, the switching circuit 1 operates in its three different operating states in a predefined order. The order, in which the three different operating states occur, is dependent on the respective state ST1-ST12 of the input voltage system, so that in each period the voltage level of the alternating voltage Vmn is given by the voltage level of highest input voltage V1 for the first time duration T201, the second highest input voltage V2 for the second time duration T202, and the voltage level of the lowest input voltage V3 for the third time duration T203. The information on the instantaneous state of the input voltage system is included in the state signal ST received by the drive signal generator 75 from the state detector 73. The information on the first, second, and third time durations T21, T22, T203 is included in the first and second time duration references T201*, T202*. The first time duration reference T201* defines the first time duration T201, the second time duration reference T202* defines the second time duration T202, and the third time duration T203 is given by the predefined overall duration T of one period of the alternating voltage Vmn minus the first and second time durations T201, T202, T203=T−T201−T202. Thus, receiving the state signal ST and the first and second time duration references T201*, T202* enables the drive signal generator 75 to control the switching circuit 1 such that the switching circuit 1 operates in the three different operating states in the correct order and for the respective correct time duration such that the alternating voltage Vmn is generated in accordance with the method explained herein before.

Referring to FIG. 20, the time duration generator 74 receives a signal that represents the highest input voltage V1 and the associated input current I1. If, for example, the first input voltage Va is the highest input voltage, the associated input current is the input current Ia received at the first input a. Furthermore, the time duration generator 74 receives a signal that represents the second highest input voltage V2 and the associated input current I2, which is the current received at the same input node at which the second highest input voltage V2 is received.

The signal representing the highest input voltage V1, the associated input current I1, the second highest input voltage V2, and the associated input current I2 are provided by a voltage/current selector 76 based on the measured (and optionally filtered) input voltages Va′, Vb′, Vc′ and the measured (and optionally filtered) input currents Ia′, Ib′, Ic′.

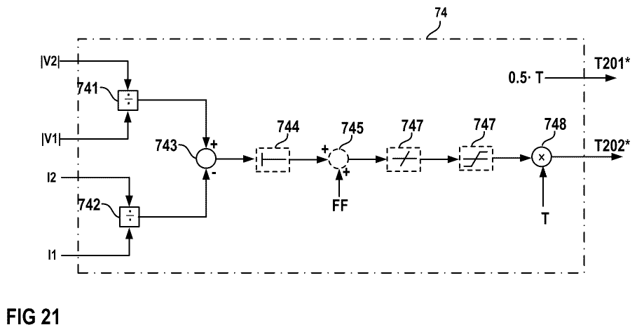

According to one example, the time duration generator 74 is configured to generate the first and second time duration references T201*, T202* based on the highest and second highest input voltage V1, V2 and the associated input currents I1, I2 for controlling the power factor. FIG. 21 illustrates one example of the time duration generator 74 in detail.

Referring to FIG. 21, the time duration generator 74 generates the first time duration reference T201* to be equal to 50% of the time duration T of one period. This is in accordance with equation (2a) provided herein above. Furthermore, the time duration generator 74 generates the second time duration reference T202* dependent on a first ratio between a magnitude |V2| of the voltage level of the second highest input voltage V2 and a magnitude |V1| of the voltage level of the highest input voltage V1, and dependent on a second ratio between a magnitude |I2| of the input current I2 associated with the second highest input voltage V2 and a magnitude |I1| of the input current associated with highest input voltage V1. The time duration generator 74 according to FIG. 21 is configured to generate the second time duration T202* such that the higher the ratio between the magnitudes |V2|, |V1| of the second highest and the highest input voltage V2, V1 the longer the second time duration reference T202*.

In the time duration generator according to FIG. 21, a first divider 741 calculates the first ratio based on the magnitudes |V2|, |V1| of the second highest and the highest input voltage V2, V1, and a second divider 742 calculates the second ratio based on the magnitudes |I2|, |I1| of the current I2 associated with the second highest input voltage V2 and the current I1 associated with the highest input voltage V1, and a subtractor 743 subtracts the second ratio from the first ratio. If, for example, the magnitudes |V2|, |V1| of the second highest and the highest input voltage V2, V1 are equal and the magnitudes |I2|, |I1| of the current I2 associated with the second highest input voltage V2 and the current I1 associated with the highest input voltage V1 are equal, the output of the subtractor 743 is this zero and the second time duration reference T202* is zero.

For generating the second time duration reference T202* based on the output of the subtractor 743, the time duration generator 74 further includes a multiplier 748 that multiplies the output of the subtractor 743 with a value that represents the time duration T of one period of the alternating voltage Vmn. Optionally, the output of the subtractor 743 is processed by at least one of the following: a proportional regulator 744 that receives the output of the subtractor 743; an adder 745 that adds a feedforward variable FF to the output of the subtractor 743; a slope limiter 747 that is configured to limit a slope of an increase or a decrease of the subtractor 743 output; or a limiter 743 that is configured to limit the subtractor output (plus the optional feedforward variable FF) to a predefined upper and lower value. The feedforward variable is selected from a range of between 0 and 1, in particular of between 0 and 0.5, for example.

By generating the alternating voltage Vmn in the way explained hereinabove, current waveforms of the input currents Ia, Ib, Ic are controlled to be dependent on voltage waveforms of the input voltages Va, Vb, Vc for controlling the power factor. More specifically, the input currents Ia, Ib, Ic are controlled such that current waveforms of the average input currents Ia, Ib, Ic correspond to the voltage waveforms of the input voltage is Va, Vb, Vc. “To correspond” in this context includes that the current waveforms have the same frequency and type of waveform as the voltage waveforms. Amplitudes of the average input currents Ia, Ib, Ic and, consequently, an amplitude of an output current Im provided at the output nodes m, n may vary dependent on the power consumption of a load connected to the power converter.

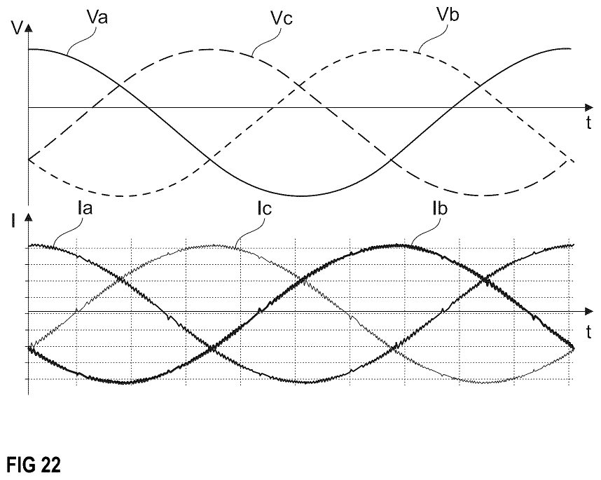

Operating the power converter in the unregulated fashion explained hereinabove results in input currents Ia, Ib, Ic that are essentially proportional to the input voltages Va, Vb, Vc so that the power factor is higher than 90% and may even be higher than 99%. FIG. 22 shows signal waveforms of the input voltages Va, Vb, Vc and signal waveforms of the corresponding input currents Ia, Ib, Ic over one period. As can be seen from FIG. 22, the input currents Ia, Ib, Ic are almost exactly proportional to the input voltages Va, Vb, Vc. and only include slight current ripples that result from the switched-mode operation of the switching circuit 1.

The output voltage Vqr and the output current Iqr may be received by a load (not illustrated in FIG. 1). According to one example, the load is a battery. In this example, the voltage level of the output voltage Vqr is defined by the battery and the output current Iqr is defined by the input power received by the power converter at the input a, b, c and the output voltage Vqr defined by the battery.

According to another example (not illustrated in FIG. 1) the output voltage Vqr is received by a DC-DC converter. According to one example, the DC-DC converter is configured to control a power received from the power converter at the output nodes q, r. According to one example, the DC-DC converter is configured to control the power received from the power converter to be at least approximately constant.

Some of the examples explained above are briefly summarized in the following with reference to numbered examples.

Example 1. A power converter, including: an input configured to receive three alternating input voltages; a switching circuit coupled to the input and including a three-phase half-bridge; an autotransformer circuit; and a rectifier circuit, wherein the autotransformer circuit is coupled between the switching circuit and the rectifier circuit, and wherein the rectifier circuit is coupled between the autotransformer circuit and an output of the power converter.

Example 2. The power converter according to example 1, further including: a resonant converter coupled to a first output node of the switching circuit.

Example 3. The power converter of example 2, wherein the resonant circuit is a series resonant circuit including a capacitor and an inductor connected in series at the first output node of the switching circuit.

Example 4. The power converter of any one of examples 1 to 3, wherein the autotransformer circuit includes an autotransformer with a first autotransformer circuit node, a second autotransformer circuit node, and a tap.

Example 5. The power converter of example 4, wherein the first autotransformer circuit node is coupled to the first output node of the switching circuit.

Example 6. The power converter of example 4 or 5, wherein the rectifier circuit includes two rectifier half-bridges each coupled between a first output node and a second output node of the output of the power converter and each including a half-bridge node, wherein the tap of the autotransformer is coupled to the half-bridge node of one of the rectifier half-bridges, and wherein the second autotransformer circuit node is coupled to the half-bridge node of the other one of the rectifier half-bridges.

Example 7. The power converter of example 6, wherein the second autotransformer circuit node is connected to a second output node of the switching circuit.

Example 8. The power converter of example 7, wherein an output filter is connected between the rectifier circuit and the output of the power converter.

Example 9. The power converter of example 6, wherein a second output node of the switching circuit is connected to the second output node of the power converter.

Example 10. The power converter of example 4 or 5, wherein the rectifier circuit includes: a rectifier half-bridge coupled between a first output node and a second output node of the output of the power converter and including a half-bridge node; and a first capacitor connected between the half-bridge node and the tap of the autotransformer.

Example 11. The power converter of example 10, wherein the rectifier circuit further includes a second capacitor connected between the first and second output nodes of the power converter.

Example 12. The power converter of example 10 or 11, wherein a second output node of the switching circuit is connected to the second output node of the power converter and the second autotransformer circuit node.

Example 13. The power converter of example 10, wherein the rectifier circuit further includes a second capacitor and a third capacitor connected in series between the first and second output nodes and connected to each other at a midpoint, and wherein the second autotransformer circuit node is connected to the midpoint.

Example 14. The power converter of example 13, wherein the second autotransformer circuit node is connected to the second output node of the switching circuit.

Example 15. The power converter of any one of the preceding examples, wherein the switching circuit includes three half-bridges each connected between the first and second output nodes of the switching circuit, and each including a switched node, and wherein each of the switched nodes is coupled to a respective one of three input nodes of the input.

Example 16. The power converter of example 15, wherein each half-bridge includes: at least one electronic switch connected between the switched node and the first output node of the switching circuit; and a capacitor connected between the switched node and the second output node of the switching circuit.

Example 17. The power converter of example 16, wherein the at least one electronic switch is a bidirectionally blocking electronic switch.

Example 18. The power converter of any one of the preceding examples, further including: an input filter connected between the input and the switching circuit.

Example 19. The power converter of any one of the preceding examples, further including: a control circuit configured to control operation of the switching circuit such that the switching circuit generates an alternating voltage based on the alternating input voltages in an unregulated fashion, controls a waveform of the alternating voltage dependent on signal levels of the input voltages, and controls a power factor of power received at the input.

Example 20. A method including: operating a power converter, wherein the power converter includes: an input configured to receive three alternating input voltages; a switching circuit coupled to the input and including a three-phase half-bridge; a resonant circuit coupled to a first output node of the switching circuit; an autotransformer circuit coupled between the switching circuit and a rectifier circuit; and the rectifier circuit coupled between the autotransformer circuit and an output of the power converter, and wherein the method includes: generating an alternating voltage based on the three alternating input voltages by the switching circuit in an unregulated fashion, thereby controlling a waveform of the alternating voltage dependent on signal levels of the input voltages, and controlling a power factor of power received at the input.

Example 21. The method according to example 20, wherein controlling the waveform of the alternating voltage and controlling the power factor includes: detecting a highest input voltage, a second highest input voltage, and a lowest input voltage of the three input voltages; and generating the alternating voltage such that in each period a voltage level of the alternating voltage at least approximately equals the voltage level of the highest input voltage for a first time period, the voltage level of the second highest input voltage for a second time period, and the voltage level of the lowest input voltage for a third time period.

Example 22. The method according to example 21, wherein an overall duration of each period of the alternating voltages is at least approximately fixed.

Example 23. The method according to example 21 or 22, wherein a duration of the first time period is at least approximately fixed.

Example 24. The method according to example 23, wherein the duration of the first time period at least approximately equals 50% of the overall duration.

Example 25. The method according to any one of examples 21 to 24, wherein a duration of the second time period is dependent on a relationship between a magnitude of the second highest input voltage and a magnitude of the second highest input voltage.

Example 26. The method according to any one of examples 21 to 25, wherein the duration of the second time period is further dependent on a relationship between a magnitude of a second current and a first current, wherein the first current is the current received at that one of the three inputs receiving the highest input voltage, and wherein the second current is the current received at that one of the three inputs receiving the second highest input voltage.

Example 27. The method according to any one of examples 21 to 26, further including: controlling a power at the output of the power converter by a further power converter.

Example 28. The method according to example 27, wherein controlling the power includes controlling the power to be at least approximately constant.

1. A power converter comprising:
an input configured to receive three alternating input voltages;
a switching circuit coupled to the input, the switching circuit comprising a three-phase half-bridge;
an autotransformer circuit; and
a rectifier circuit;
wherein the autotransformer circuit is coupled between the switching circuit and the rectifier circuit, and
wherein the rectifier circuit is coupled between the autotransformer circuit and an output of the power converter.

2. The power converter according to claim 1, further comprising:
a resonant converter coupled to a first output node of the switching circuit.

3. The power converter of claim 2,
wherein the resonant circuit is a series resonant circuit comprising a capacitor and an inductor connected in series at the first output node of the switching circuit.

4. The power converter of claim 1,
wherein the autotransformer circuit comprises an autotransformer with a first autotransformer circuit node, a second autotransformer circuit node, and a tap.

5. The power converter of claim 4, wherein the first autotransformer circuit node is coupled to the first output node of the switching circuit.

6. The power converter of claim 5,
wherein the rectifier circuit comprises two rectifier half-bridges each coupled between a first output node and a second output node of the output of the power converter and each comprising a half-bridge node,
wherein the tap of the autotransformer is coupled to the half-bridge node of one of the rectifier half-bridges, and
wherein the second autotransformer circuit node is coupled to the half-bridge node of the other one of the rectifier half-bridges.

7. The power converter of claim 6,
wherein the second autotransformer circuit node is connected to a second output node of the switching circuit.

8. The power converter of claim 7,
wherein an output filter is connected between the rectifier circuit and the output of the power converter.

9. The power converter of claim 6,
wherein a second output node of the switching circuit is connected to the second output node of the power converter.

10. The power converter of claim 5, wherein the rectifier circuit comprises:
a rectifier half-bridge coupled between a first output node and a second output node of the output of the power converter and comprising a half-bridge node; and
a first capacitor connected between the half-bridge node and the tap of the autotransformer.

11. The power converter of claim 10,
wherein the rectifier circuit further comprises a second capacitor connected between the first and second output nodes of the power converter.

12. The power converter of claim 11,
wherein a second output node of the switching circuit is connected to the second output node of the power converter and the second autotransformer circuit node.

13. The power converter of claim 10,
wherein the rectifier circuit further comprises a second capacitor and a third capacitor connected in series between the first and second output nodes and connected to each other at a midpoint, and
wherein the second autotransformer circuit node is connected to the midpoint.

14. The power converter of claim 13,
wherein the second autotransformer circuit node is connected to the second output node of the switching circuit.

15. The power converter of claim 1,
wherein the switching circuit comprises three half-bridges each connected between the first and second output nodes of the switching circuit, and each comprising a switched node, and
wherein each of the switched nodes is coupled to a respective one of three input nodes of the input.

16. The power converter of claim 15, wherein each half-bridge comprises:
at least one electronic switch connected between the switched node and the first output node of the switching circuit; and
a capacitor connected between the switched node and the second output node of the switching circuit.

17. The power converter of claim 16,
wherein the at least one electronic switch is a bidirectionally blocking electronic switch.

18. The power converter of claim 1, further comprising:
an input filter connected between the input and the switching circuit.

19. The power converter of claim 1, further comprising:
a control circuit configured to control operation of the switching circuit such that the switching circuit
generates an alternating voltage based on the alternating input voltages in an unregulated fashion,
controls a waveform of the alternating voltage dependent on signal levels of the input voltages, and
controls a power factor of power received at the input.

20. A method comprising:
operating a power converter,
wherein the power converter comprises:
an input configured to receive three alternating input voltages;
a switching circuit coupled to the input and comprising a three-phase half-bridge;
a resonant circuit coupled to a first output node of the switching circuit;
an autotransformer circuit coupled between the switching circuit and a rectifier circuit; and
the rectifier circuit coupled between the autotransformer circuit and an output of the power converter, and
wherein the method comprises:
generating an alternating voltage based on the three alternating input voltages by the switching circuit in an unregulated fashion, thereby controlling a waveform of the alternating voltage dependent on signal levels of the input voltages, and controlling a power factor of power received at the input.
